(19) United States
(12) Patent Application Publication
(10) Pub. No.: US 2006/0103040 A1
(43) Pub. Date: May 18, 2006

(54) Synchronous operation starting method for injection molding machines

(75) Inventor: Hideaki Shirai, Ohbu-shi (JP)

Correspondence Address: BROWDY AND NEIMARK, P.L.L.C.;624 NINTH STREET, NW, SUITE 300, WASHINGTON, DC, 20001-5303, US

(73) Assignee: Kabushiki Kaisha Meiki Seisakusho, Ohbu-shi (JP)

(21) Appl. No.: 11/270,556

(22) Filed: Nov. 10, 2005

(30) Foreign Application Priority Data
Nov. 12, 2004 (JP) 2004-328932

(51) Int. Cl. B29D 17/00

(52) U.S. Cl. 264/1.33; 264/169

(57) ABSTRACT

A method for synchronously starting operations of two injection molding machines 1, 6 comprising the steps of starting automatic operations of two injection molding machines 1, 6 at different points in time; sending synchronizing commands 20 to the two injection molding machines 1, 6 which are carrying out the automatic operations; adding a predetermined time C which is shorter than a molding cycle time to one of the injection molding machines receiving the synchronizing commands 20 between two consecutive steps in a molding cycle, to extend the molding cycle time; and starting synchronous operations of the two injection molding machines 1, 6 in a same step when a step corresponding to a step subsequent to the predetermined time C in the one injection molding machine is carried out in the other injection molding machine while the one injection molding machine carries out an operation in the predetermined time C.

### BACKGROUND OF THE INVENTION

1. Field of the Invention

The present invention relates to a synchronous operation starting method for two injection molding machines to form a DVD disk or the like by bonding disk components molded synchronously.

2. Description of Related Art

Japanese Unexamined Patent Publication (Kokai) No. 2001-113581 discloses a synchronous operation for two injection molding machines used for forming a DVD disk by bonding disk components that are synchronously molded. Japanese Unexamined Patent Publication (Kokai) No. 2001-113581 discloses that predetermined operations in a plurality of injection molding machines are synchronously started with respect to the starting point of the predetermined operation in an injection molding machine in which the predetermined operation begins at the latest point in time. Specifically, controllers of the plural injection molding machines are provided with input/output ports that send/receive an actuation enabling signal, respectively, and each controller of the injection molding machine generates starting signals when receives actuation enabling signals from the other controllers to actuate actuators of the injection molding machines.

A recent DVD disk forming operation has been accelerated, and one molding cycle time is less than 3 seconds. If the synchronous operation method disclosed in Japanese Unexamined Patent Publication (Kokai) No. 2001-113581 is applied to such a DVD disk forming operation, as the predetermined operations in the injection molding machines are synchronously started with respect to the starting point of the predetermined operation in an injection molding machine in which the predetermined operation begins at the latest point in time, the injection molding machines other than the injection molding machine in which the predetermined operation begins at the latest point in time wait in a state prior to the predetermined operation. The waiting time extends to about one molding cycle time at worst. Accordingly, a nozzle set at a relatively low temperature in preparation for the reduction of the molding cycle time is cooled by abutting with a die, so that defects such as silver streaks occur on a surface of the molded disk component due to the reduction of viscosity of molten resin that is cooled too much, and the nozzle is blocked due to solidification of the molten resin.

### BRIEF SUMMARY OF INVENTION

In order to solve the above problems, the present invention provides a method for synchronously starting operations of two injection molding machines used for forming a DVD disk or the like by bonding disk components that have been synchronously molded, comprising the steps of starting automatic operations of two injection molding machines at different points in time; sending synchronizing commands to the two injection molding machines which are carrying out the automatic operations; adding a predetermined time which is shorter than a molding cycle time to one of the injection molding machines receiving the synchronizing commands between two consecutive steps in a molding cycle, to extend the molding cycle time; and starting synchronous operations of the two injection molding machines in a same step when a step corresponding to a step subsequent to the predetermined time in the one injection molding machine is carried out in the other injection molding machine while the one injection molding machine carries out an operation in the predetermined time.

### BRIEF DESCRIPTION OF INVENTION

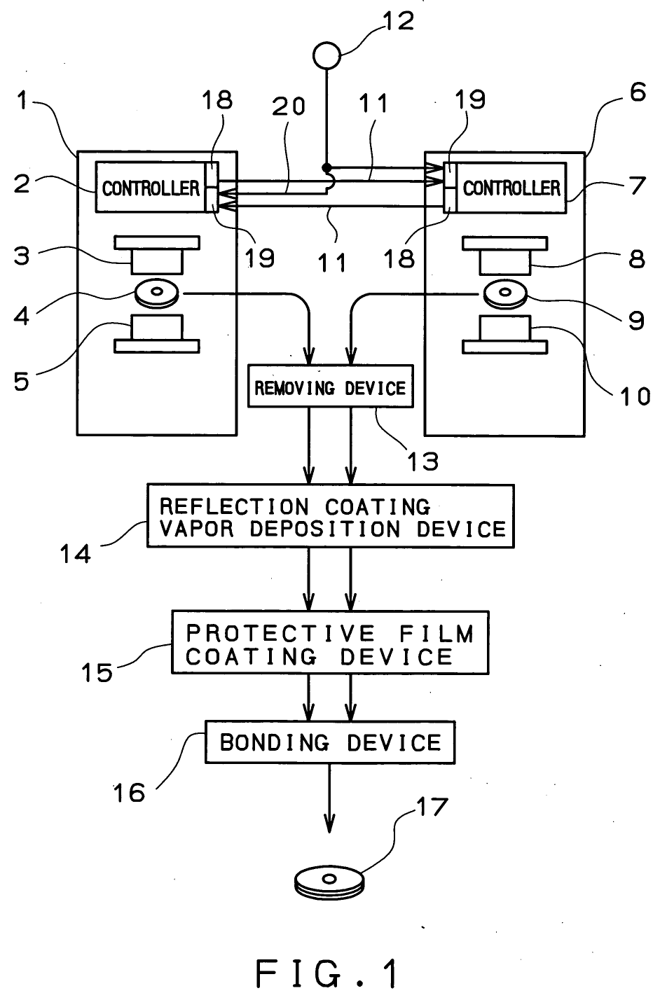

FIG. 1 is a block diagram of an embodiment of the present invention, in which steps for molding disk components using two injection molding machines to form a DVD disk are shown.

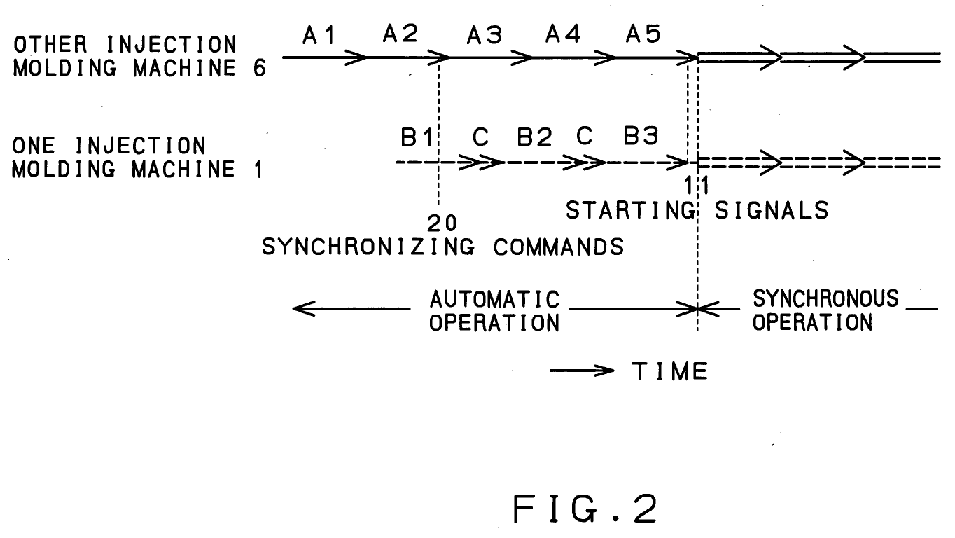

FIG. 2 is a time chart of an embodiment of a synchronous operation starting method according to the present invention.

### DETAILED DESCRIPTION OF INVENTION

Injection molding machines 1, 6 are provided with controllers 2, 7 which control a clamping device or an injection device (not shown) in accordance with a predetermined sequence. The clamping device opens/closes and clamps a pair of dies 3, 5 and 8, 10, to mold disk components 4, 9 in cooperation with the injection device. An operation sequence in an automatic operation for molding is comprised of an intermediate time, a die closing step, a clamping step, an injection step, a cooling step and a die opening step. The disk components 4, 9 formed in cavities formed by the dies 3, 5 and 8, 10 are removed from the cavities by a removing device 13 during the intermediate time, and protective film-coated surfaces of disk substrates of the disk components are bonded by a bonding device 16, via a reflection coating vapor deposition device 14 and a protective film coating device 15, to complete a DVD disk 17.

The intermediate time means a time elapsed from the completion of the die opening operation to the beginning of the die closing operation, and is set and controlled by timers provided in the controllers 2, 7. However, in the disk forming operation in which the reduction of a forming time is required, the die closing operation may be started upon removal of the disk components 4, 9 using the removing device 13 before the timers complete measuring the intermediate time.

The controllers 2, 7 of the injection molding machines 1, 6 have sequencers which store the same ladder sequence, respectively, and automatically operate the injection molding machines 1, 6 in the die closing step, the clamping step, the injection step, the cooling step and the die opening step, based on a position signal input from an actuator of the clamping device or the injection device of the injection molding machine to the controllers 2, 7 via input ports 19, and the timers provided in the controllers 2, 7, during time other than the above intermediate time. Here, the generation of starting signals 11 each comprised of a die closing signal for starting a die closing operation, an injection signal for starting an injecting operation and a die opening signal for starting a die opening operation is set in the ladder sequence of respective controllers 2, 7. The starting signals 11 are input/output from the controller 2 to the controller 7 or vice versa, via output ports 18 and the input ports 19. Namely, the controller 2 of the injection molding machine 1 and the controller 7 of the injection molding machine 6 are communicated with each other via the starting signals 11, and the starting signals 11 generated from one of the injection molding machines is sent to the other injection molding machine. Push-button switches 12 are connected to the input ports 19 of the controllers 2, 7, respectively. The push-button switches 12 are provided on the injection molding machines 1, 6, respectively, and any of the push-button switches 12 is pushed to send a signal including synchronizing commands 20 to the controllers 2, 7.

A method for starting a synchronous operation for the injection molding machines will be described below. For example, when the injection molding machine 6 has started an automatic operation before the injection molding machine 1 starts the same, and the starting signals 11 as die closing signals for starting one molding cycle are issued from the controller 7, the controller 7 of the injection molding machine 6 recognizes and stores that the injection molding machine 6 has started the automatic operation before the injection molding machine 1 starts the same because it does not receive the starting signals 11 from the injection molding machine 1. At this time, the controller 2 of the injection molding machine 1 recognizes and stores, when the injection molding machine 1 starts the automatic operation, that the injection molding machine 1 starts the automatic operation after the injection molding machine 6 has started the same because the controller 2 does not generate the starting signals 11, and receives the starting signals 11 from the injection molding machine 6. In the injection molding machines 1 and 6, whichever starts the automatic operation prior to the other, the above-described calculation is carried out.

As shown in FIG. 2, when, for example, the injection molding machine 1 starts an automatic operation at a molding cycle B1 while the injection molding machine 6 carries out an automatic operation at a molding cycle A2, the injection molding machines carry out the respective automatic operations at a substantially identical molding cycle time. However, the automatic operations are started at different points in time and, accordingly, a synchronous operation is not carried out. In this state, when an operator actuates a push-button switch 12 during the molding cycle A2 or B1, synchronizing commands 20 are input to the controllers 2, 7. Any one of the controllers of the injection molding machines, which have received the synchronizing commands 20, carries out a calculation to extend the molding cycle. The controller which carries out the calculation to extend the molding cycle is the controller 2 if, for example, the injection molding machine that starts the automatic operation later is selected or set to recognize and store the above-described beginning time of the automatic operation. At this time, the controller 2 add a predetermined time C to the molding cycle after receiving the synchronizing commands 20, to extend the molding cycle time. The timing of adding the predetermined time C is set between two consecutive steps in the injection molding machine 1, preferably before the die closing step, the injection step or the die opening step, and more preferably, before the die closing step (this state is shown in FIG. 2). The predetermined time C is shorter than and preferably about 30% of the molding cycle time. If the predetermined time C is too long, the problem of the present invention cannot be sufficiently solved, and if the predetermined time C is too short, a time that elapses until the synchronous operation begins is increased. The synchronizing commands 20 are issued by actuating the push-button switch 12 as described above. However, if the injection molding machine which starts the automatic operation later (injection molding machine 1) carries out a calculation to extend the molding cycle, the synchronizing commands may be automatically issued when the injection molding machine starts the automatic operation.

The state in which the injection molding machine 1 carries out the automatic operation to extend the molding cycle while the injection molding machine 6 carries out the automatic operation, will be described below. When a step in the injection molding machine 6 corresponding to a step (die closing step) subsequent to the predetermined time C in the injection molding machine 1 begins while the injection molding machine 1 carries out an operation at the predetermined time C, the injection molding machines 1 and 6 start a synchronous operation in a same step (die closing step) based on the starting signals 11 which are generated and sent by the injection molding machine 6 and received by the injection molding machine 1. In other words, when the injection molding machine 6 starts the die closing step while the injection molding machine 1 carries out an operation at the predetermined time C after the intermediate time, the injection molding machine 1 synchronously starts the die closing step. In this state, as a matter of course, the predetermined time C added to the injection molding machine 1 and the extension of the molding cycle in the injection molding machine 1 are cancelled.

The extension of the molding cycle in the injection molding machine 1 which starts the automatic operation later has been described above. However, even if the molding cycle in the injection molding machine 6 which starts the automatic operation prior to the injection molding machine 1 is extended, a synchronous operation can be started in the same manner described above. If one of the injection molding machines stops in a continuous synchronous operation and, thereafter, the injection molding machine is restarted to begin the synchronous operation, the extension of the molding cycle in the other injection molding machine which does not stop has a problem in a molding operation. Therefore, it is preferable that the injection molding machine which starts the automatic operation later is selected as an injection molding machine in which the molding cycle is extended.

Therefore, according to the present invention, two injection molding machines can be reliably and easily synchronized by the above means. Also, the present invention is not limited to the above-described embodiment, and several modifications may be made therein without departing from the gist of the invention.

What is claimed is:

1. A method for synchronously starting operations of two injection molding machines used for forming a DVD disk by bonding disk components that have been molded at the same time, comprising the steps of
starting automatic operations of two injection molding machines at different points in time;
sending synchronizing commands to the two injection molding machines which are carrying out the automatic operations;
adding a predetermined time which is shorter than a molding cycle time to one of the injection molding machines receiving the synchronizing commands between two consecutive steps in a molding cycle, to extend the molding cycle time,; and
starting synchronous operations of the two injection molding machines in a same step when a step corresponding to a step subsequent to the predetermined time in the one injection molding machine is carried out in the other injection molding machine while the one injection molding machine carries out an operation in the predetermined time.

2. A synchronous operation starting method for injection molding machines according to claim 1, wherein the one of the injection molding machines is an injection molding machine which starts an automatic operation later.

3. A synchronous operation starting method for injection molding machines according to claim 1, wherein the synchronizing commands are issued when a push-button switch connected to a controller of the injection molding machine is actuated.

4. A synchronous operation starting method for injection molding machines according to claim 1, wherein the predetermined time is added prior to a die closing step, an injection step or a die opening step in a molding cycle.

5. A synchronous operation starting method for injection molding machines according to claim 2, wherein the synchronizing commands are issued when a push-button switch connected to a controller of the injection molding machine is actuated.

6. A synchronous operation starting method for injection molding machines according to claim 2, wherein the predetermined time is added prior to a die closing step, an injection step or a die opening step in a molding cycle.
